(19) United States
(12) Patent Application Publication
(10) Pub. No.: US 2010/0054009 A1
(43) Pub. Date: Mar. 4, 2010

(54) CURRENT CONVERSION CIRCUIT

(75) Inventor: JUN-JONG CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/262,175

(22) Filed: Oct. 30, 2008

(30) Foreign Application Priority Data
Aug. 29, 2008 (CN) 200810304296.0

(51) Int. Cl. H02M 7/537

(52) U.S. Cl. 363/131

(57) ABSTRACT

A current conversion circuit includes a control circuit, and a switch circuit. The control circuit includes a first photoelectric coupler receiving a first driving signal and outputting a first control signal, and a second photoelectric coupler receiving a second driving signal and outputting a second control signal. The switch circuit includes a first transistor and a second transistor connected in series between a positive power source and a negative power source. The first transistor includes a control terminal receiving the first control signal, and the second transistor includes a control terminal receiving the second control signal. A node between the first and second transistors outputs an alternating signal.

### BACKGROUND

1. Technical Field

Embodiments of the present disclosure relate to conversion circuits, and particularly to a circuit for converting direct current (DC) signals to alternating current (AC) signals.

2. Description of Related Art

Generally, a DC to AC current conversion circuit in motor drivers comprises a number of switch elements connected in series between positive and negative power sources. However, the switch elements have the risk of being simultaneously turned on which causes a short circuit between the positive and negative power sources, and damages components in the motor drivers.

What is needed, therefore, is a current conversion circuit for safely and steadily converting DC signals to AC signals.

### BRIEF DESCRIPTION OF THE DRAWINGS

FIG. 1 is a circuit diagram of an exemplary embodiment of a current conversion circuit connected to a motor.

FIG. 2 is a circuit diagram of another exemplary embodiment of a current conversion circuit connected to a motor.

### DETAILED DESCRIPTION

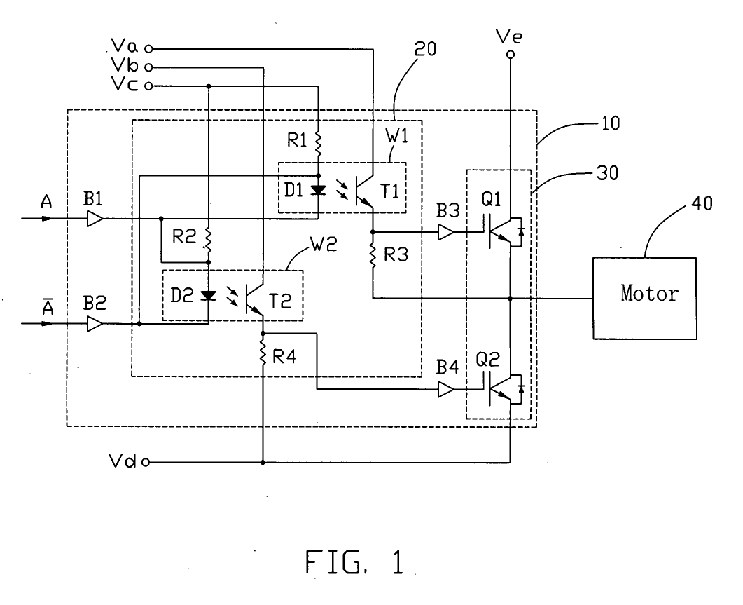

Referring to FIG. 1, an exemplary embodiment of a current conversion circuit 10 includes a control circuit 20, four buffers B1, B2, B3, and B4, and a switch circuit 30. In one embodiment, the switch circuit 30 includes a first switch element Q1 and a second switch element Q2. The first and second switch elements Q1, Q2 are metal oxide semiconductor field effect transistors (MOSFETs) in one exemplary embodiment. The control circuit 20 includes a first photoelectric coupler W1 and a second photoelectric coupler W2, and four resistors R1, R2, R3, and R4. The first photoelectric coupler W1 includes a first light emitting diode (LED) D1 and a first photoelectric transistor T1. The second photoelectric coupler W2 includes a second LED D2 and a second photoelectric transistor T2. An anode of the first LED D1 is connected to a positive voltage source Vc through the resistor R1, and to a cathode of the second LED D2. A cathode of the first LED D1 is connected to a buffer B1 for receiving a driving signal A, and to an anode of the second LED D2. The anode of the second LED D2 is connected to the positive voltage source Vc through the resistor R2. The cathode of the second LED D2 is connected to a buffer B2 for receiving a driving signal Ā which is complementary with the driving signal A. A collector of the first photoelectric transistor T1 is connected to a positive voltage source Va. A collector of the second photoelectric transistor T2 is connected to a positive voltage source Vb. An emitter of the first photoelectric transistors T1 is connected to a source of the first switch element Q1 through the resistor R3, and to a gate of the first switch element Q1 through the buffer B3. An emitter of the second photoelectric transistors T2 is connected to a negative voltage source Vd through the resistor R4, and to a gate of the second switch element Q2 through the buffer B4. A drain of the first switch element Q1 is connected to a positive voltage source Ve. A source of the second switch element Q2 is connected to the negative voltage source Vd. The source of the first switch element Q1 is connected to a drain of the second switch element Q2 which acts as an output terminal of the current conversion circuit 10 to connect to a motor 40.

When the driving signal A is high and the driving signal Ā is low, the first LED D1 turns off, and the second LED D2 turns on. The first photoelectric transistor T1 and the first switch element Q1 turn off. The second photoelectric transistor T2 and the second switch element Q2 turn on. When the driving signal A is low and the driving signal Ā is high, the first LED D1 turns on, and the second LED D2 turns off. The first photoelectric transistor T1 and the first switch element Q1 turn on. The second photoelectric transistor T2 and the second switch element Q2 turn off. The first and second switch elements Q1, Q2 alternately works, and the current conversion circuit 10 outputs an AC signal which drives the motor 40 to work.

When the driving signals A and Ā are low, and the absolute voltage difference between the driving signals A and Ā is less than about 0.7V, the first and second LEDs D1 and D2 turn off. Similarly, when the driving signals A and Ā are high, and the absolute voltage difference between the driving signals A and Ā is less than about 0.7V, the first and second LEDs D1 and D2 also turn off. The first and second photoelectric transistors T1 and T2 turn off. The first and second switch elements Q1 and Q2 turn off, which avoids forming a short circuit between the positive voltage source Ve and the negative voltage source Vd.

When both the driving signals A and Ā are low or high, and a voltage value of the driving signal A is greater than about 0.7V a voltage value of the driving signal Ā, the first LED D1 turns off and the second LED D2 turns on. The first photoelectric transistor T1 and the first switch element Q1 turn off. The second photoelectric transistor T2 and the second switch element Q2 turn on. The first and second switch elements Q1 and Q2 alternately works to avoid forming a short circuit between the positive voltage source Ve and the negative voltage source Vd. When both the driving signals A and Ā are low or high, and the voltage value of the driving signal Ā is greater than about 0.7V the voltage value of the driving signal A, the first LED D1 turns on, and the second LED D2 turns off. The first photoelectric transistor T1 and the first switch element Q1 turn on. The second photoelectric transistor T2 and the second switch element Q2 turn off. The first and second switch elements Q1, Q2 alternately works to avoid forming a short circuit between the positive voltage source Ve and the negative voltage source Vd.

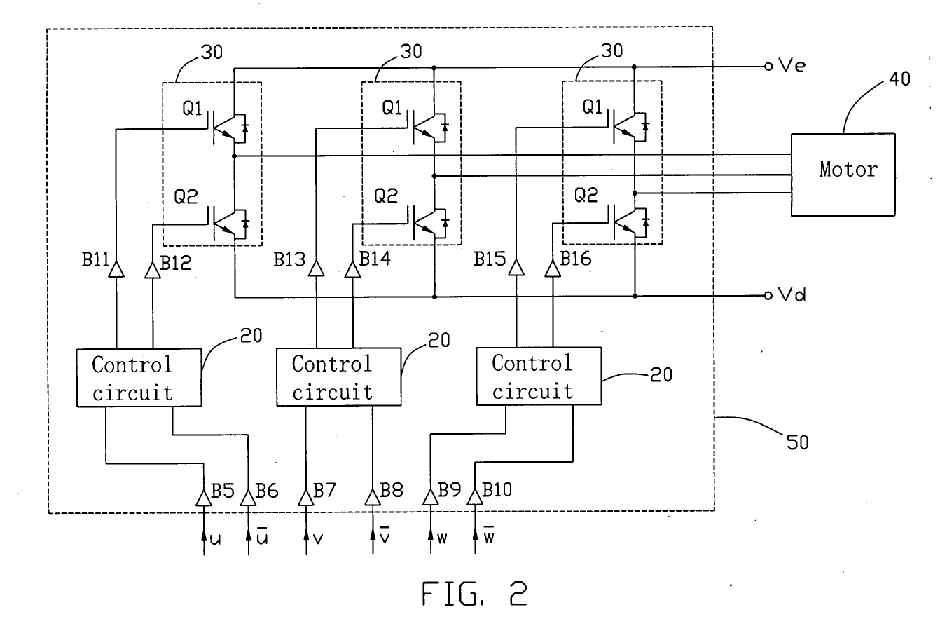

It is understood that the first and second switch elements Q1 and Q2 can be other types of switch elements, such as bipolar junction transistors (BJTs). The current conversion circuit 10 can include a plurality of switch circuits 30 and a plurality of control circuits 20. As shown in FIG. 2, a current conversion circuit 50 includes three switch circuits 30, twelve buffers B5, B6, B7, B8, B9, B10, B11, B12, B13, B14, B15, and B16, and three control circuits 20. The first control circuit 20 controls the first switch circuit 30 through the buffers B11 and B12. The second control circuit 20 controls the second switch circuit 30 through the buffers B13 and B14. The third control circuit 20 controls the third switch circuit 30 through the buffers B15 and B16. The first control circuit 20 receives a driving signal u through the buffer B5, and a driving signal ū through the buffer B6. The second control circuit 20 receives a driving signal v through the buffer B7, and a driving signal v̅ through the buffer B8. The third control circuit 20 receives a driving signal w through the buffer B9, and a driving signal w̅ through the buffer B10. The driving signals received by each control circuit 20 are complementary and have a 120 degree polarity difference to the driving signals received by other control circuits 20.

The foregoing description of the certain inventive embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skill in the art to which the present disclosure pertains without departing from its spirit and scope. Accordingly, the scope of the present disclosure is defined by the appended claims rather than the foregoing description and the embodiments described therein.

What is claimed is:

1. A current conversion circuit, comprising:
at least one control circuit, each control circuit comprising:
a first photoelectric coupler comprising a first light emitting diode (LED) comprising a cathode and an anode connected to a first positive voltage source, and a first photoelectric transistor comprising a collector connected to a second positive voltage source and an emitter for outputting a first control signal;
a second photoelectric coupler comprising a second LED comprising an anode connected to the first positive source and the cathode of the first LED to receive a first driving signal, and a cathode connected to the anode of the first LED to receive a second driving signal, and a second photoelectric transistor comprising a collector connected to a third positive voltage source and an emitter for outputting a second control signal;
at least one switch circuit, each switch circuit comprising:
a first switch element comprising a control terminal connected to the emitter of the first photoelectric transistor to receive the first control signal, a first terminal connected to a fourth positive voltage source, and a second terminal; and
a second switch element comprising a control terminal connected to the emitter of the second photoelectric transistor to receive the second control signal, a first terminal connected to the second terminal of the first switch element to output an alternating signal, and a second terminal connected to the negative voltage source.

2. The current conversion circuit of claim 1, wherein the current conversion circuit further comprises a first resistor and a second resistor, the second terminal of the first switch element is connected to the emitter of the first photoelectric transistor through the first resistor, and the second terminal of the second switch element is connected to the emitter of the second photoelectric transistor through the second resistor.

3. The current conversion circuit of claim 1, wherein the current conversion circuit further comprises a first resistor and a second resistor, the anode of the first LED is connected to the first positive voltage source through the first resistor, and the anode of the second LED is connected to the first positive voltage source through the second resistor.

4. The current conversion circuit of claim 1, wherein the first and second switch elements are metal oxide semiconductor field effect transistors (MOSFETs), the control terminal of each switch element is a gate of the MOSFET, the first terminal of each switch element is a drain of the MOSFET, the second terminal of each switch element is a source of the MOSFET.

5. The current conversion circuit of claim 1, wherein the anode of the second LED receives the first driving signal through a first buffer, and the cathode of the second LED receives the second driving signal through a second buffer.

6. The current conversion circuit of claim 1, wherein the control terminal of the first switch element is connected to the emitter of the first photoelectric transistor through a first buffer, and the control terminal of the second switch element is connected to the emitter of the second photoelectric transistor through a second buffer.

7. The current conversion circuit of claim 1, wherein the first and second driving signals are complementary to each other.

8. The current conversion circuit of claim 1, wherein the at least one control circuit comprises three control circuits, the at least one switch circuit comprises three switch circuits, the first and second driving signals received by each control circuit are complementary and have a 120 degree polarity difference to the first and second driving signals received by other control circuits, thereby the switch circuits outputting three alternating signals.
